(19) United States
(12) Patent Application Publication
(10) Pub. No.: US 2014/0058939 A1
(43) Pub. Date: Feb. 27, 2014

(54) METHOD AND APPARATUS FOR PROCESSING PAYMENT TRANSACTIONS FROM A CHAT APPLICATION INTEGRATED WITH A PAYMENT APPLICATION THAT LEVERAGES SOCIAL FEATURES FROM THE CHAT APPLICATION

(71) Applicant: Sumit Hasmukh Savla, Santa Clara, CA (US)

(72) Inventor: Sumit Hasmukh Savla, Santa Clara, CA (US)

(73) Assignee: eBay Inc., San Jose, CA (US)

(21) Appl. No.: 13/594,472

(22) Filed: Aug. 24, 2012

(51) Int. Cl. G06Q 40/02

(52) U.S. Cl. 705/42

(57) ABSTRACT

A system for processing payment transactions and social features from a messaging or chat application with an integrated payment application. An example embodiment includes: integrating a payment application into a client messaging application; linking a payment button with the payment application; receiving a payment request through the client messaging application from a client user via the payment button; using the payment application to identify an account on a payment site that corresponds to the payment request; and performing a payment transaction with the identified account corresponding to the payment request at the payment site via the payment application. The embodiment is configured to facilitate social sharing functions including: inviting users to download the payment application, sharing a contact list among a plurality of payment application users, inviting users to chat from the payment application, and updating a user profile in the client messaging application by the payment application.

### BACKGROUND

1. Technical Field

This application relates to a method and system to process data. Particularly, this application relates to the processing of payment transactions and social features from a messaging or chat application with an integrated payment application.

2. Related Art

These days, millions of smartphone users use Instant Messaging (IM) clients like BBM, Whatapp, Apple's iMessage, KiK messenger, etc. All of these mobile IM client applications (apps) keep users connected with their friends and family. These apps are overtaking Short Message Service (SMS) messaging by enabling users to do many things. Users can plan events/outings, collaborate work, talk, play games, discuss interests, study with their classmates and many other things together with their friends and family. However, at present, there is no way for users to perform payment activities with their pals using mobile IM client applications. For example, conventional mobile IM client applications cannot be used to pay for movie tickets, pay for a work team party, pay rent, send gifts, or payback loans to friends and family. As a result, we all need to keep reminding each other about payments as people do forget. Of course, it takes time to do bank transfers or use payment apps or open websites to pay. ATM payments are inconvenient. In general, there is no way to use conventional mobile IM client applications to process payments right from the messaging or chatting app where people are spending lots of their time.

### BRIEF DESCRIPTION OF THE DRAWINGS

Embodiments illustrated by way of example and not limitation in the figures of the accompanying drawings, in which:

FIG. 1 illustrates an example embodiment of a networked system in which various embodiments may operate;

FIG. 2 is a block diagram illustrating multiple applications that, in one example embodiment, can be provided as part of an example system;

FIG. 3 illustrates various data structures that, in one example embodiment, can be provided as part of an example system;

FIG. 4 illustrates an example embodiment of a messaging system with client users and a payment system in network communication;

FIGS. 5-6 illustrate example embodiments of a user interface of a messaging or chat application (app) for integrating a payment application with a payment (e.g., ‘Send Money’) button with the messaging or chat application (app);

FIGS. 7-11 illustrate example embodiments of a user interface with a payment app with a payment (e.g., ‘Send Money’) button integrated with a messaging or chat application (app) and for supporting social features with a payment app integrated with a messaging or chat app;

FIG. 12 illustrates a processing flow diagram for an example embodiment; and

FIG. 13 shows a diagrammatic representation of a machine in the form of a computer system within which a set of instructions, for causing the machine to perform any one or more of the methodologies discussed herein, may be executed, according to an example embodiment.

### DETAILED DESCRIPTION

In the following description, for purposes of explanation, numerous specific details are set forth in order to provide a thorough understanding of some example embodiments. It will be evident, however, to one of ordinary skill in the art that the various embodiments may be practiced without these specific details.

According to various example embodiments described herein, there is described a method and apparatus for processing payment transactions from a chat application integrated with a payment application that leverages social features from the chat application. In an example embodiment, donation, payment, or giving functionality associated with messaging or chat functionality can be implemented on a messaging or chat system (e.g., Instant Messaging (IM) clients like BBM, Whatapp, Apple's iMessage, KiK messenger), or a message content source or facilitator, content provider site, on-line goods or services provider, a blog system, a community forum system, a bulletin board system, a forms system, a network-based social network system, such as FACEBOOK.COM OR TWITTER.COM, or a network-based marketplace, such as EBAY.COM or any other system via which a user may publish/post or receive messages on a network (e.g., the Internet), with the support of a payments or financial system (e.g., a networked banking system or payment system, e.g., PAYPAL.COM).

The various embodiments described herein provide a way to do payment right when the people are chatting with others. The various embodiments can be very convenient and very quick. In various embodiments, the following use cases are enabled: a user can send Thanksgiving/Diwali gifts from BBM; a user can send money from WhatApp; a user can settle bills via iMessage; a user can share recent payback/purchase/gifts with his/her buddies. In short, the various embodiments described herein can enable a user to pay from the native phone menus using IM apps.

Some of the IM platforms, like BlackBerry and KiK messenger, have opened their messaging platform for the developers to do tighter integration. Additionally, these platforms enable users to make use of the growing mobile social platforms. In an example embodiment, a payment service (e.g., Paypal) can be integrated with these IM systems. In a particular embodiment, a payment service (e.g., Paypal) can be integrated with BlackBerry Messenger.

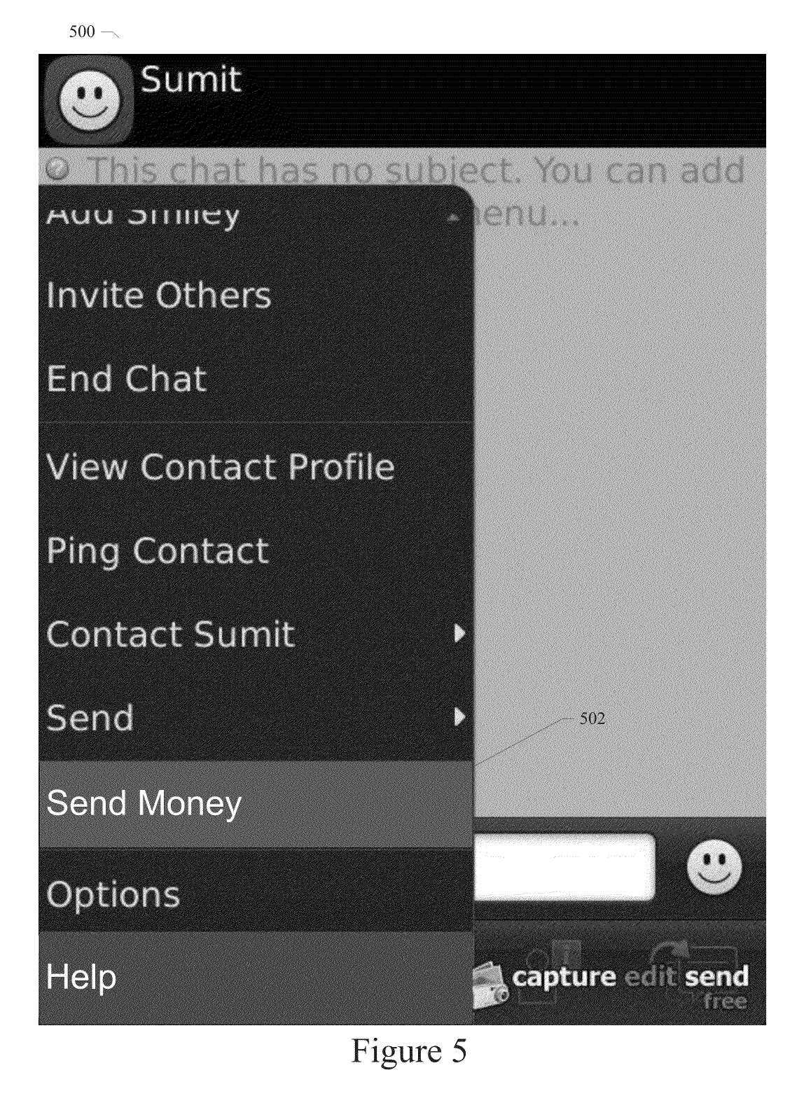

Various embodiments relate to integrating payment functionality with messaging or chat functionality to prompt a consumer or viewer (chat participant) for donations or payment related to a messaging or chat session provided via a network. Particular embodiments do not require payment from the consumer/viewer prior to making the message content available to the consumer/viewer. Various embodiments relate to allowing a user to set up functionality to solicit and obtain donations or payment associated with a messaging or chat session integrated with a payment system backend (e.g., PayPal) in support of a payment (e.g., ‘Send Money) button provided on the messaging system or host site or with other functionality for effecting the publication/posting, viewing, or consumption of the associated message content. In the case where a sender/receiver of the money doesn't have a PayPal account, the sender/receiver will be invited to join. In one embodiment, if a receiving user is not on PayPal, then a PayPal Sign Up or Login form can be displayed in the receiving user's chat window or chat display area on a mobile device. In an example embodiment, the payment functionality is activated through a ‘Send Money’ button linked with a user's payment system account (e.g., PayPal) and a message content participant's receivables account (e.g., PayPal). Examples of such a ‘Send Money’ button in particular embodiments are shown in FIGS. 5 through 7 described in more detail below.

In one embodiment, a client messaging application with an integrated payment application can be further configured to facilitate social sharing functions including: inviting users to download the payment application, sharing a contact list among a plurality of payment application users, inviting users to chat right from the payment application, and updating a user profile in the client messaging application by the payment application.

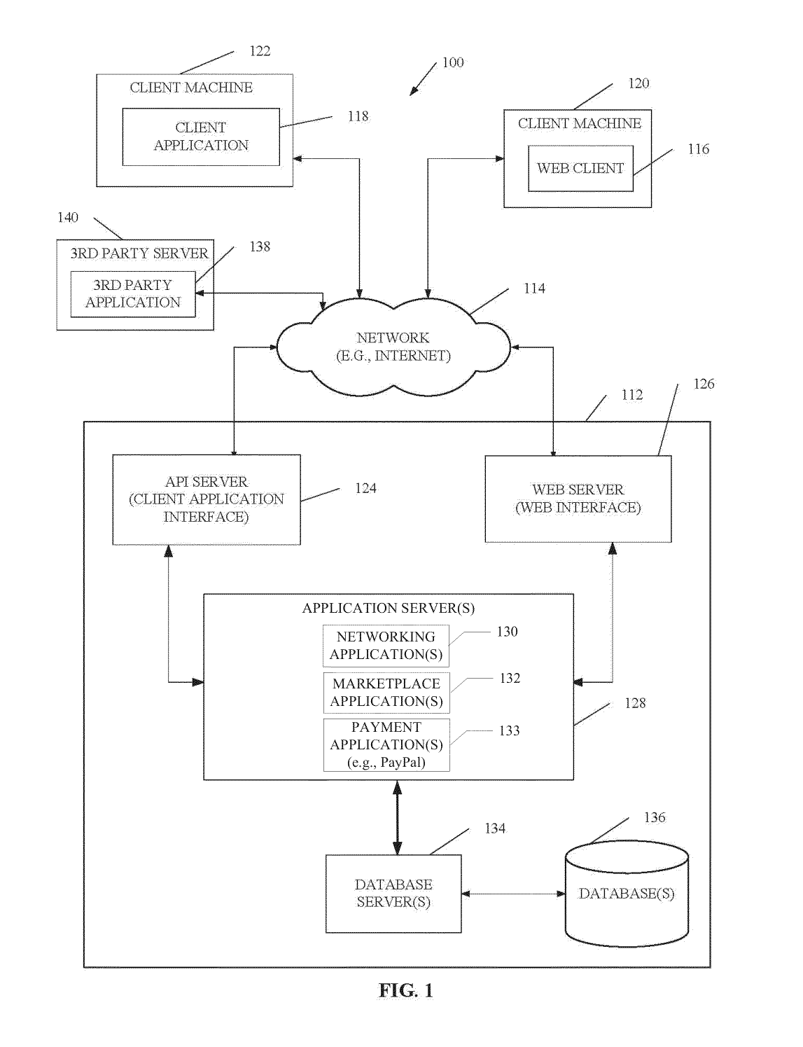

Referring now to FIG. 1, a message/data exchange platform, in an example embodiment of a network-based message/data provider (or host system/site) 112, provides server-side functionality, via a network 114 (e.g., the Internet) to one or more clients. The one or more clients may include users who may utilize the network system 100 and more specifically, the network-based provider 112, to exchange messages or data over the network 114. Users may use network-based provider 112 to invite other users to chat or initiate a chat or messaging session. These transactions may include transmitting, receiving (communicating) messages and processing data to and from the multitude of users.

The data may include, but is not limited to, user data including, instant messages, chat messages, user image data, user gesture data, user preference information, user profile information, ad search queries, search keywords, shopping or listing context information and/or identifiers, context data, notations (e.g., personal and public shopping notes), context filter data, shared electronic shopping carts, product and service reviews, product, service, manufacture, and vendor recommendations and identifiers, product and service listings associated with buyers and sellers, auction bids, feedback, etc. In one embodiment, the user information can be associated with one or more contexts generated by a user or other users and maintained on the network-based provider 112. Data associated with a user, such as any of the data described above, may be publicly shared as determined by the originator of the data.

Turning specifically to the network-based messaging system 112, an application program interface (API) server 124 and a web server 126 are coupled to, and provide programmatic and web interfaces respectively to, one or more application servers 128. The application servers 128 host one or more networking application(s) 130, marketplace application(s) 132, and payment application(s) 133. The application servers 128 are, in turn, shown to be coupled to one or more databases servers 134 that facilitate access to one or more databases 136.

In one embodiment, the web server 126 may send and receive data pertaining to a user, message, or item listing via a toolbar installed on a browser application. The toolbar may allow for a user or a third party to, inter alia, send or receive a message, create a new user profile (a profile creator), selectively add a uniform resource locator (URL) associated with the created user profile, and create notations regarding research and general matters associated with the user profile. In other embodiments, the web server may serve a page or the API server 124 in conjunction with the client application 118 may provide the same or similar functionality as that described with reference to the toolbar. It may be noted that using a toolbar within an application such as a browser or stand-alone application is well known in the art.

The marketplace application(s) 132 may provide a number of marketplace functions and services (e.g., item listings, searching, advertisement, payment, etc.) to users that access the network-based marketplace 112. The networking application(s) 130 likewise may provide a number of consumer services, merchant services, or social networking services and functions to users. The networking application(s) 130 may allow a user to generate one or more contexts related to shopping or advertisement (ad) generation, which may include listings (e.g., for products and services) couched as a broad category associated with a consumer, a class of consumers, and/or an item (e.g., a product or service or a listing for a product or service) or class of items. Additionally, listings can be couched as associated with a specific consumer or a specific item. For example, listings in the form of a category could be, “jackets” or “shoes.” Similarly, a context can include a user profile associated with a category of users or a specific user. For example, a user profile in the form of a category could be, “women over 40 years old” or “purchasers of sports apparel.” An example of a user profile in a more specific form may be, “a user profile for John A. Smith of Akron, Ohio” or “purchasers of Nike running shoes.” The level of specificity may vary and is selectable by the user profile creator or administrator of the interactive shopping engine of a particular embodiment. For example, the user profile can be as specific as a particular person or the associated listing associated with a make, model, additional specific attributes or features of a specific item or service offered for sale or lease.

In one embodiment, the networking application(s) 130 and marketplace application(s) 132 may provide a client (e.g., web client 116) with an interface that includes input fields for personality or item/listing attributes most commonly selected by other users as the most important or most determinative attributes related to the products/services which a user/consumer is seeking or selling. For example, a multitude of users may have indicated they thought the most important personality attributes for the user profile include information related to: 1) consumer/user need, 2) general consumer/user personality, 3) consumer/user shopping attitude, and 4) consumer/user budget. A multitude of other users may have indicated they thought the most important item attributes for a sports apparel purchaser user profile include: 1) sports apparel brand, 2) cost, and 3) size. These user profile attributes may be independently developed or discovered by the network-based marketplace 112 by processing the attribute data received from the multitude of users or may be based on the user profile creator ranking the attributes or a combination thereof.

The networking application(s) 130 may allow the user profile creator or interactive shopping engine user to distribute the one or more user profiles to one or more groups defined by the user profile creator or interactive shopping engine user (e.g., “my family,” “my friends,” etc.) or to groups at various levels in a predefined category (e.g., “running group,” “sports apparel group,” or “Nike running shoe group,” etc.).

While the networking application(s) 130 and the marketplace application(s) 132 are shown in FIG. 1 to form part of the network-based marketplace 112, it will be appreciated that, in alternative embodiments, the networking application(s) 130 may form part of a social networking service that is separate and distinct from the network-based marketplace 112.

FIG. 1 also illustrates a third party application 138, executing on a third party server machine 140, as having programmatic access to the network-based marketplace 112 via the programmatic interface provided by the API server 124. For example, the third party application 138 may, utilizing information retrieved from the network-based marketplace 112, support one or more features or functions on a website hosted by the third party. The third party website may, for example, provide one or more networking, marketplace or payment functions that are supported by the relevant applications of the network-based marketplace 112.

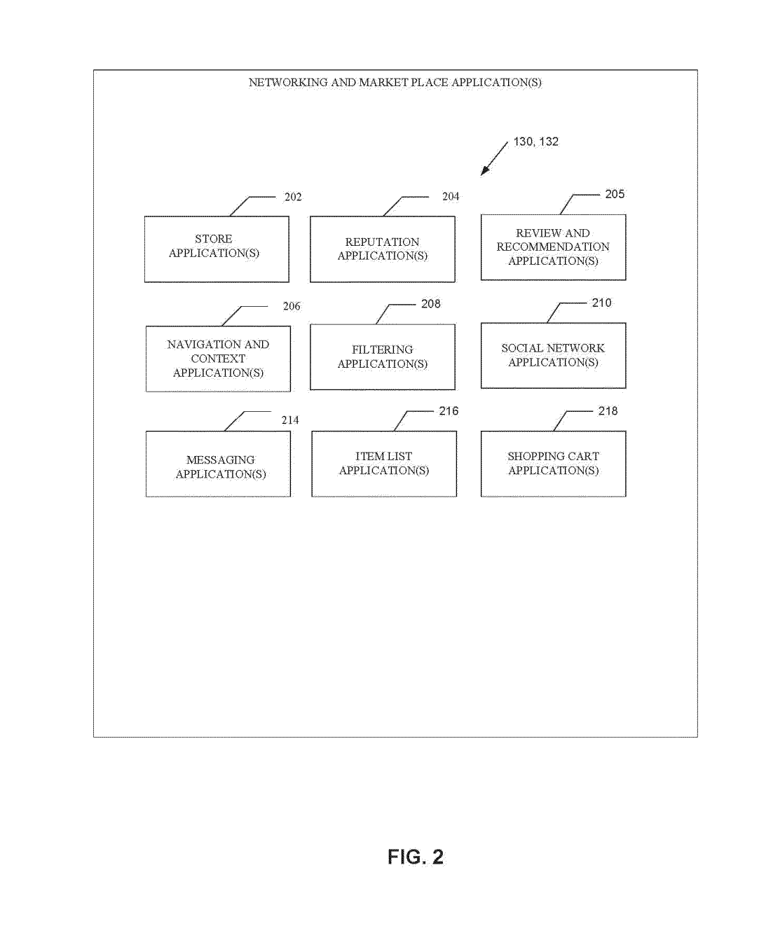

FIG. 2 is a block diagram illustrating an example embodiment of multiple network and marketplace application(s) 130 and 132, respectively, which can be provided as part of the network-based messaging system 112. The network-based messaging system 112 may provide a number of feeds or listings for goods and/or services, category-based shopping, social networking, and purchase and bidding systems, various levels of features provided for users, and price-setting mechanisms whereby a seller may list goods and/or services (e.g., for sale, bid, or lease) and a buyer may buy or bid on listed goods and/or services. A user profile and context associated with a user shopping or listing an item in the network-based marketplace 112 may offer or provide information that may be helpful in assisting the interactive shopping engine user in customizing their shopping or listing experience pertaining to the user profile or listing information (i.e., context). Among various embodiments, the recommendations, reviews, or research notes corresponding to the user profile or listing information may be directed from another user to one or more users desiring data associated with the user profile or listing information or the data may be provided from storage by the network and marketplace application(s) 130 and 132 based on the user profile or listing information provided by a user. The data may be provided based on a request from the user profile creator or automatically pushed to the user profile creator based on policy or a user configuration file.

To this end, the network and marketplace application(s) 130 and 132, respectively, are shown to include one or more application(s) which support the network-based marketplace 112, and more specifically the generation and maintenance of one or more user profiles provided by users of the network-based marketplace 112 or interactive shopping engine users. These applications can include support for activities associated with the user profiles and listing information, including storing and retrieving user notes, web sites (URLs), links associated with related tags, research and notes from other users and community members, related community groups, vendors, providing localized geographic data for user profiles (e.g., regional or country-specific consumer purchasing patterns), etc. Additionally, the various applications may support social networking functions, including building and maintaining the community groups created by a user, which may be helpful in providing various types of data (e.g., reviews, notes, local services, consumer information, etc.) pertaining to the user profiles and listing information.

Store application(s) 202 may allow sellers to group their listings (e.g., goods and/or services) within a “virtual” store, which may be branded and otherwise personalized by and for the sellers. Such a virtual store may also offer promotions, incentives and features that are specific and personalized to a relevant seller and consumer. In one embodiment, based on the user profiles provided by the user profile creator, the virtual store may be provided to the user profile creator or interactive shopping engine user where the virtual store may carry or sell an item or service related to a user's need based on the user profile.

Reputation application(s) 204 may allow parties that transact utilizing the network-based marketplace 112 to establish, build, and maintain reputations, which may be made available and published to potential trading partners. Consider that where, for example, the network-based marketplace 112 supports person-to-person trading, users may have no history or other reference information whereby the trustworthiness and/or credibility of potential trading partners may be assessed. The reputation application(s) 204 may allow a user, for example through feedback provided by other transaction partners, to establish a reputation within the network-based marketplace 112 over time. Other potential trading partners may then reference such a reputation for the purposes of assessing credibility, trustworthiness, or the like. A user creating a user profile and seeking reviews, research (e.g., notes, etc.), and recommendations associated with the profile may filter the result data from the search or context submission based on reputation data. For example, the user profile creator may only want profile data such as reviews and research notes pertaining to the user profile from other users with a greater than 3 out of 5 star reputation rating.

In one embodiment, the network-based messaging system 112 includes review and recommendation application(s) 205. The social networking application(s) 210 may work in conjunction with the review and recommendation application(s) 205 to provide a user interface to facilitate the entry of reviews of the user profile data received from other users. A review may be a text entry of the community group member's opinion, a standard review form including check boxes indicating a level satisfaction, or a combination of both, etc. Recommendations may include a specific type of demographic, item, a specific brand or service for a type of item, a specific retailer for the item, etc.

Navigation of the network-based messaging system 112 may be facilitated by one or more navigation and context application(s) 206. For example, a context application may, inter alia, enable key word searches of item listings associated with a context defined by a user profile of a particular consumer. The context can include an association between the user profile data in the user profile and item feature sets related to items in the item listings. The item listings can include listings from a group including products or services or both. The item feature set data and data defining the association between the user profile data in the user profile and item feature sets may be retrieved from the network-based messaging system 112 (e.g., databases 136) or from various other remote sources, such as other network sites, other users (e.g., experts or peers), etc. In one embodiment, a toolbar installed on a browser application may be used for functions including interactive and navigation functions to create a new user profile, selectively add a uniform resource locator (URL) associated with the created user profile, and create notations regarding research and general matters associated with the user profile. These functions may be user accessible by many methods known in the art, including a web form interface (HTML or embedded Java) or a stand-alone application interface. For example, a navigation application may include a browser that allows users via an associated user interface to browse a user's user profile, various item listings, item feature sets, contexts, catalogues, inventories, social networks, and review data structures within the network-based marketplace 112. In one embodiment, the user interface includes selectable elements in the form of tabs to separate out various categories of user profile data that when selected generate a list associated with the category. For example, a tab for “My Notes,” a tab for “Everyone's Notes,” a tab for “Buy,” and a tab for “Sell”. Various other navigation applications (e.g., an external search engine) may be provided to supplement the search and browsing applications.

In one embodiment, using filtering application(s) 208, the user or interactive shopping engine user may customize result data associated with a user profile or listing search results. The filtering application(s) 208 may generate the result data according to one or more rules provided by the network-based marketplace 112 and the user receiving the filtered result data. For example, as discussed above with reference to the reputation application(s) 204, the user may only want the user profile to match on item listings pertaining to item reviews from other users with a greater than 3 out of 5 star reputation rating. In another example, the user may only want user profile data to match on item listings pertaining to item listings with a particular feature set or attribute set. For example, the user may only want result data for Nike shoes with a size equal or greater than size 10-wide. Additionally, the filtering rules may be combinable or modifiable to broaden or narrow the scope of the result data. The filtering application(s) 208 may also be used to implement rules for granting or allowing access to the user profile data.

Messaging application(s) 214 may be used for the generation and delivery of messages to users of the network-based messaging system 112. For example, the user may like a particular review or research from another user and may wish to contact the user for additional information. In one embodiment, the messaging application(s) 214 may be used in conjunction with the social networking application(s) 210 to provide promotional and/or marketing (e.g., targeted advertisements associated with the user profile) to the user or a related user from vendors and community members that may have offerings related to the user profile.

Item list application(s) 216 may be used in the network-based marketplace 112 by the user to create an item list based on selecting one or more items and services to purchase (or sell, auction, lease, or donate), which may be at least partially based on result data associated with the user's shopping experience. The item list application(s) 216 may be accessed via a user interface that allows the user to create and use the item list. Additionally, the user may selectively share this list within a community or to all users to gain or solicit additional data such as vendor recommendations for each purchase or vendor reviews for vendors that may be present in the list.

In one embodiment, electronic shopping cart application(s) 218 are used to create a shared electronic shopping cart used by a user to add and store items from a shopping list generated by the user (e.g., by making selections from a “Buy” tab). The electronic shopping cart application(s) 218 may facilitate the transactions for each item on the list by automatically finding the items in the electronic shopping cart across at least one or all of a set of vendors, a comparison shopping site, an auction site, other user's ads, etc. In one embodiment, a multitude of transactions may appear as one transaction based on the selection of “Bulk Purchase.” In various embodiments, the selection criteria for which vendor or vendors to purchase from may include, but is not limited to, criteria such as lowest cost, fastest shipping time, preferred or highest rated vendors or sellers, or any combination thereof.

It will be appreciated that one or more of the various sample networking and marketplace application(s) 130, 132 may be combined into a single application including one or more modules. Further, in some embodiments, one or more applications may be omitted and additional applications may also be included.

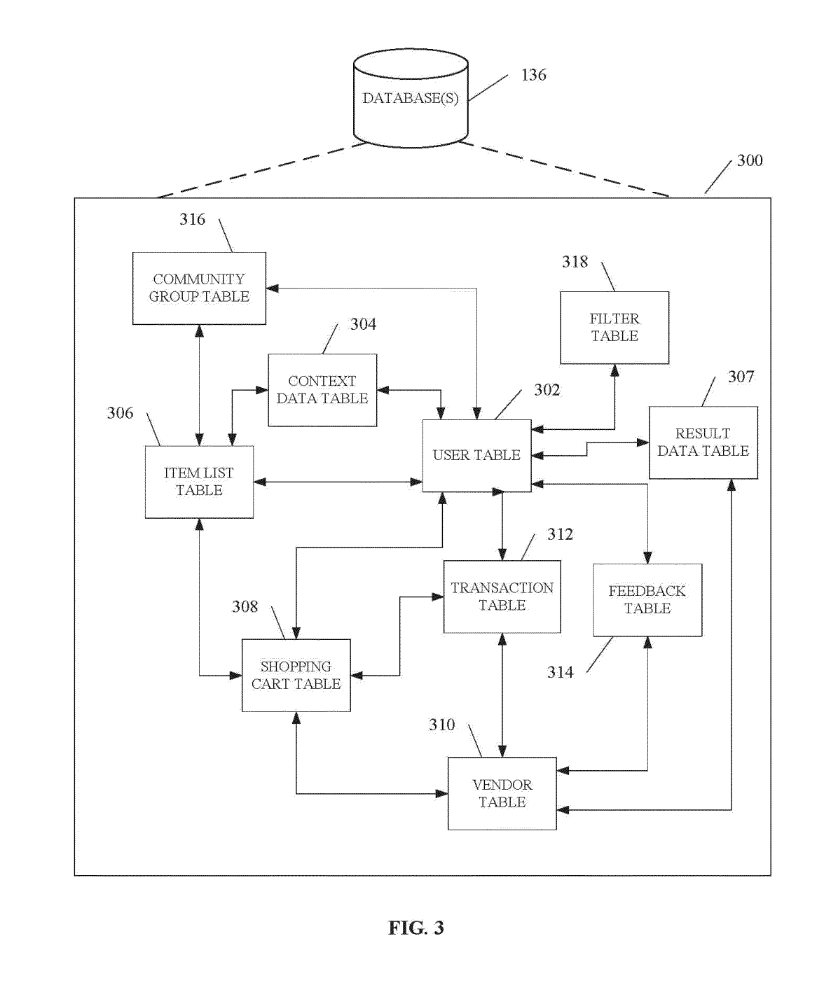

FIG. 3 is a high-level entity-relationship diagram, in accordance with an example embodiment, illustrating various data structures or tables 300 that may be maintained within the database(s) 136 (see FIG. 1), which may be utilized by and support the networking and marketplace application(s) 130 and 132, respectively. A user table 302 may contain a record for each registered user of the network-based messaging system 112, and may include identifier, address and financial instrument information pertaining to each such registered user. In one embodiment, a user operates as one or all of an interactive shopping system user, a seller, or a buyer, within the network-based messaging system 112.

The context data table 304 maintains a record of the one or more user profiles and/or listings created by or related to a user. As discussed above, this may include user profile identifiers and/or listing identifiers that may include words and/or phrases from the general to the specific for a consumer class, specific consumer, product/service class, or a specific product/service. Context data in context data table 304 can also include associations between the user profile data in the personalized consumer profiles and item feature sets related to items in the item listings. The item listings can be listings for products or services or both. The personalized consumer profiles, item feature set data, and data defining the association between the user profile data in the personalized consumer profiles and item feature set data may be stored into or retrieved from the context data table 304 of database(s) 136. In one embodiment, each word in a phrase may be a tag linked to another user profile and its associated data. For example “Nike” may be a selectable element within the user interface as a tag that results in the selector receiving more general data regarding Nike products. Similarly, “sports apparel” may be selected to receive more general data regarding sports apparel.

The tables 300 may also include an item list table 306, which maintains listing or item records for goods and/or services that were created using the item list application(s) 216. In various embodiments, the item list may be created and shared with a community group or to all users in part to solicit feedback regarding listed or potential vendors.

Each listing or item record within the item list table 306 may furthermore be linked to one or more electronic shopping cart records within an electronic shopping cart table 308 and to one or more user records within the user table 302 and/or a vendor table 310, so as to associate a seller or vendor and one or more actual or potential buyers from the community group with each item record.

A transaction table 312 may contain a record for each transaction pertaining to items or listings for which records exist within the item list table 306. For example, the transaction table 312 may contain a purchase or sales transaction of an item of the item list by a consumer.

In one example embodiment, a feedback table 314 may be utilized by one or more of the reputation application(s) 204 to construct and maintain reputation information associated with users (e.g., members of the community group, messaging or chat participants, buyers, sellers, etc.).

Group(s) of users found in a community group table 316 may be selected by a user to be members of a community group having access to user profile data and an item listing associated with the electronic shopping cart.

A filter table 318 may be used to sort and filter data associated with a user profile. The sorted or filtered data are then stored in the result data table 307 and linked to the user profile creator via a user profile identifier. Various types of filters and associated rules were discussed above with reference to the filtering application(s) 208 in FIG. 2.

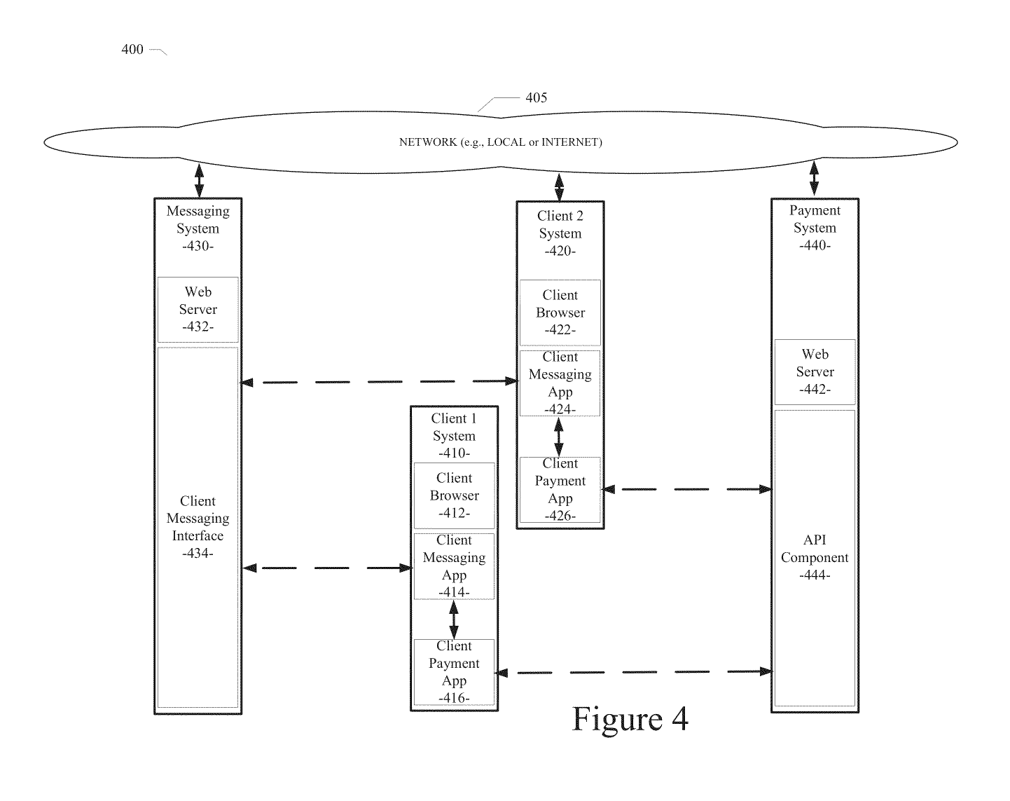

Referring to FIG. 4, a networked messaging environment 400 is shown to include client systems 410 and 420, a messaging site or messaging system 430, and a payment site 440. Client systems 410 and 420 represent client systems for client users. Client systems 410 and 420 can represent personal computers with a standard client browser 412 and 422 (e.g., Microsoft Internet Explorer) and a network connection to public network 405 (e.g. the Internet). Client systems 410 and 420 can also represent client mobile devices (e.g., mobile phones, iPhones, personal digital assistants, tablet computers, and the like), which can communicate wirelessly with a network, such as network 405 for the transfer of messages and data between users of client devices 410 and 420. Client systems 410 and 420 can include a client browser 412/422, and/or a client messaging app 414/424. Using conventional systems, a user can operate client system 410 or 420 to perform messaging or chat functions with a client messaging interface 434 of messaging site 430 via network 405.

Messaging site or messaging system 430 represents a conventional messaging or chat server/computer with a standard web server 432 and a network connection to public network 405 (e.g. the Internet). A messaging system operator can operate messaging site 430 to route messages between client systems 410 and 420 and perform e-commerce or financial transactions (described in more detail below) with a client systems 410 and 420 via network 405. The messaging site 430 typically maintains a data repository in which message information, user information, and transaction information can be stored and queried. It will be apparent to those of ordinary skill in the art that the data repository may equivalently be remotely connected to messaging site 430 (e.g., via a network).

Payment site or payment system 440 represents a conventional payment server/computer (e.g., a site operated by PayPal) with a standard web server 442, API component 444, and a network connection to public network 405 (e.g. the Internet). A financial service provider can operate payment site 440 to perform e-commerce and/or financial transactions with client systems 410 and 420 via network 405. The payment site 440 typically maintains a data repository in which client information and financial information can be stored and queried. It will be apparent to those of ordinary skill in the art that the data repository may equivalently be remotely connected to payment site 440 (e.g., via a network).

In addition to the conventional networked messaging platform described above, client systems 410 and 420 may also be configured to process payment or financial transactions from a messaging or chat application. In support of this feature of the various embodiments, client systems 410 and 420 include a client payment app 416/426. The client payment app 416/426 represents a module of processing instructions to enable a client device, including a mobile device, to perform payment or financial transactions from a messaging or chat application. In an alternative embodiment, the client payment app 416/426 functionality can be incorporated into the client messaging app 414/424. The app/apps can be downloaded and installed in a client device using conventional means. The client messaging app 414/424 can be modified to include a “Send Money” button in a client messaging user interface, as described in more detail below. The “Send Money” user interface enables a messaging or chat app user to configure a client device to perform a payment or financial transactions from a messaging or chat application. As shown in FIG. 4, the client messaging app 414/424 can be modified to notify the client payment app 416/426 when the client user wishes to perform a payment or financial transaction (e.g., such as by activating the “Send Money” button). When this occurs, the client payment app 416/426 can be configured to perform a network data interaction with the payment site 440 via network 405 as shown in FIG. 4 (dashed lines in FIG. 4 indicate a logical data interaction). This network data interaction can include transmitting pre-configured user credentials and account information to the payment site 440 for authentication. This network data interaction can also include transmitting a pre-configured log-in request to the payment site 440. As described in more detail below, the network data interaction can also include information indicating the amount of money to be paid, information indicating the identity of the payee and/or a payee account, and a message to be included with the payment. This network data interaction can occur from the client user's messaging or chat app and can occur while the client user is using the messaging or chat app to chat with other client users. Once the payment or financial transaction is complete, the payment site 440 can send a confirmation of payment (or error message) to the client payment app 416/426. The client payment app 416/426 can forward the confirmation of payment (or error message) to the client messaging app 414/424, which can display the confirmation of payment (or error message) to the client user. In another embodiment, an email or push notification can be sent after the payment is complete.

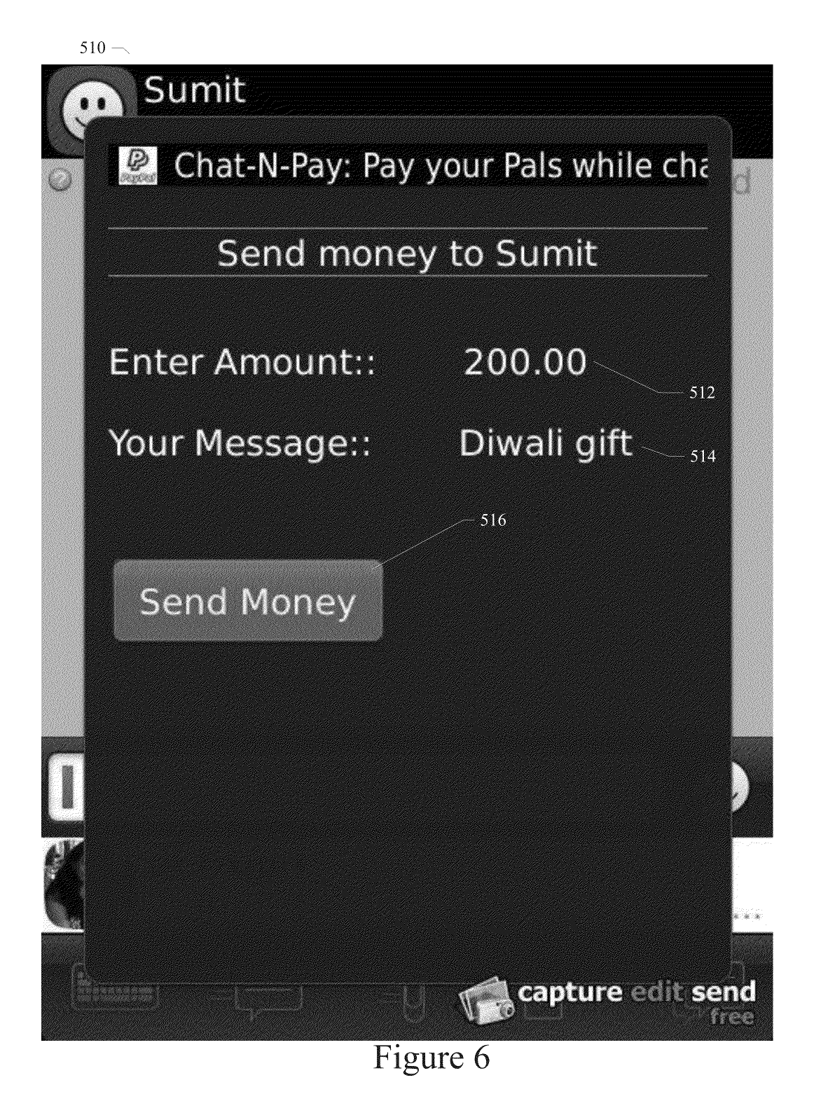

Referring now to FIGS. 5-6, example embodiments illustrate a user interface for integrating a payment (e.g., ‘Send Money’) button with a messaging or chat application (app). As shown in FIG. 5, a user interface 500 of an example embodiment shows a set of buttons that can be activated by a user of a mobile device. The user interface 500 can be generated and displayed by a client messaging app 414/424. As shown in FIG. 5, the user interface 500 has been configured to include a ‘Send Money’ button 502. A user of the client device (e.g., a mobile client device) can activate the ‘Send Money’ button 502 in a conventional manner. Once activated, the user interface 510 shown in FIG. 6 is displayed to the client user.

Referring now to FIG. 6, the user interface 510 is shown after a user of the client device (e.g., a mobile client device) activates the ‘Send Money’ button 502. The user interface 510, in an example embodiment, is configured to enable a user to specify an amount 512 and a message 514 to be sent with the financial transaction. The identity of the payee can be selected from the list of contacts provided in a conventional messaging or chat application. In an alternative embodiment, the user interface 510 can prompt the user to provide the identity of the payee and/or a payee account identifier. The user interface 510 also provides a ‘Send Money’ button 516, which can be used to submit the payment transaction.

Once the user completes entry of the information prompted by user interface 510, the ‘Send Money’ button 516 is highlighted as shown in FIG. 6. The user can activate the highlighted ‘Send Money’ button 516 provided in user interface 510 shown in FIG. 6. When the highlighted ‘Send Money’ button 516 is activated by the user, the financial transaction information provided by the user via user interface 510 is sent from the client messaging app 414/424 to the payment site 440 via the client payment app 416/426 and network 405 as described above. The payment site 440 can process the financial transaction in a conventional manner. As described above, the client payment app 416/426 can be configured to perform a network data interaction with the payment site 440 via network 405 as shown in FIG. 4. This network data interaction can include transmitting pre-configured user credentials and account information to the payment site 440 for authentication. This network data interaction can also include transmitting a pre-configured log-in request to the payment site 440. The network data interaction can also include information indicating the amount of money to be paid as specified by the user via user interface 510, information indicating the identity of the payee and/or a payee account as specified by the user, and a message to be included with the payment as provided by the user. This network data interaction can occur from the client user's messaging or chat app and can occur while the client user is using the messaging or chat app to chat with other client users. Once the payment or financial transaction is complete, the payment site 440 can send a confirmation of payment (or error message) to the client payment app 416/426. The client payment app 416/426 can forward the confirmation of payment (or error message) to the client messaging app 414/424, which can display the confirmation of payment (or error message) to the client user.

In an initial series of operations, a chat client user can set up a payables or receivables account using a conventional on-line account provider (e.g. PayPal). The payables or receivables account can be linked to the chat client user and a mobile device of the chat client user. Further, an identifier (e.g., account number) of the payables and/or receivables account of the chat client user can be linked to the client payment app 416/426 and used in association money paid by or to the chat client user. Upon activation of the ‘Send Money’ button by a sending chat client user, the identifier of the payables account of the sending chat client user can be forwarded to a payment system 440 (e.g., PayPal). Additionally, the identity of the payee can be forwarded to the payment system 440. The payment system 440 can query the client payment app 416/426 of the receiving chat client user to obtain an identifier of a receivables account associated with the receiving chat client user. The payment system 440 can use the identifier of the receivables account associated with the receiving chat client user to enable the payment system 440 to credit the payment to the appropriate account of the receiving chat client user. Account identifiers, names, numbers, or other sensitive information can be encrypted or obfuscated to protect the information from third party access.

The payment system 440 (e.g., PayPal) backend can provide validation for the transfer of value between the chat client users. For example, the payment system 440 can validate the accounts of payor and payee and validate the transferred amount. In addition, the payment system 440 backend may track how much value is transferred by each chat client user. Further, the payment system backend may track how much value is paid or received by a particular chat client user.

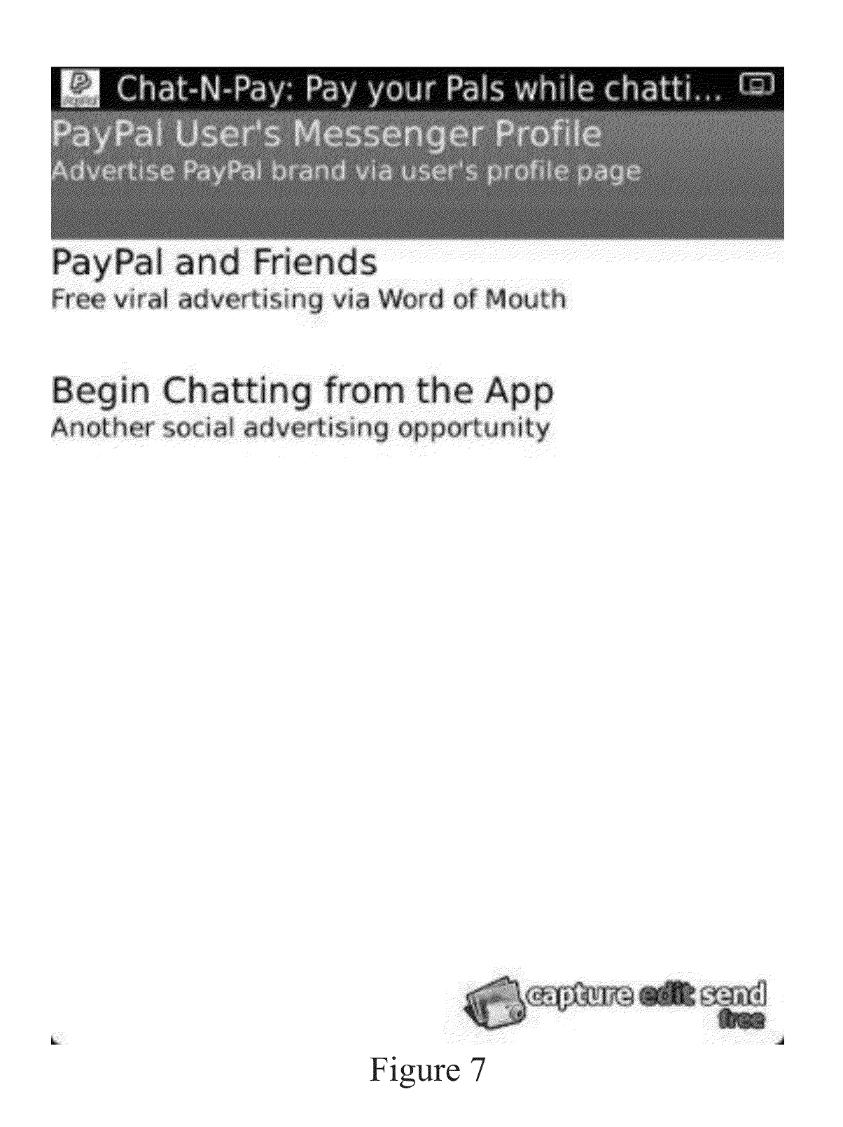

In another embodiment, a native payment application (app), (e.g., a PayPal native app) can be used. This can be implemented using the client messaging app 414/424 and the client payment app 416/426 that is integrated with messaging system 430. In this implementation, a user can launch the native client payment app 416/426 and then using integrated messaging system 430 API's, the native client payment app can pop up all the IM contacts or contacts found in the client user's address book and then allow user to pay or get paid. Then, the actual transaction flow is similar to the flow described above. Following completion of the financial transaction, the sender/receiver can receive notification in their IM chat window or mobile display area after request. FIGS. 7 through 11 describe a user interface of an example embodiment in which a native payment application (app) is provided and used.

Referring now to a particular embodiment illustrated in FIG. 7, a native payment application (app) can be integrated with the messaging system. Payment app menu options can be shown from the messaging system user interface. In this embodiment, a user can launch the payment app and then using integrated messaging system APIs, the payment app can pop up all the messaging system contacts or contacts found in the address book and then allow the user to pay or get paid using the available contacts. The actual transaction flow using the payment app is similar to the payment flow described above. Once the payment transaction is complete, the sender/receiver can receive notification in messaging system chat window after request.

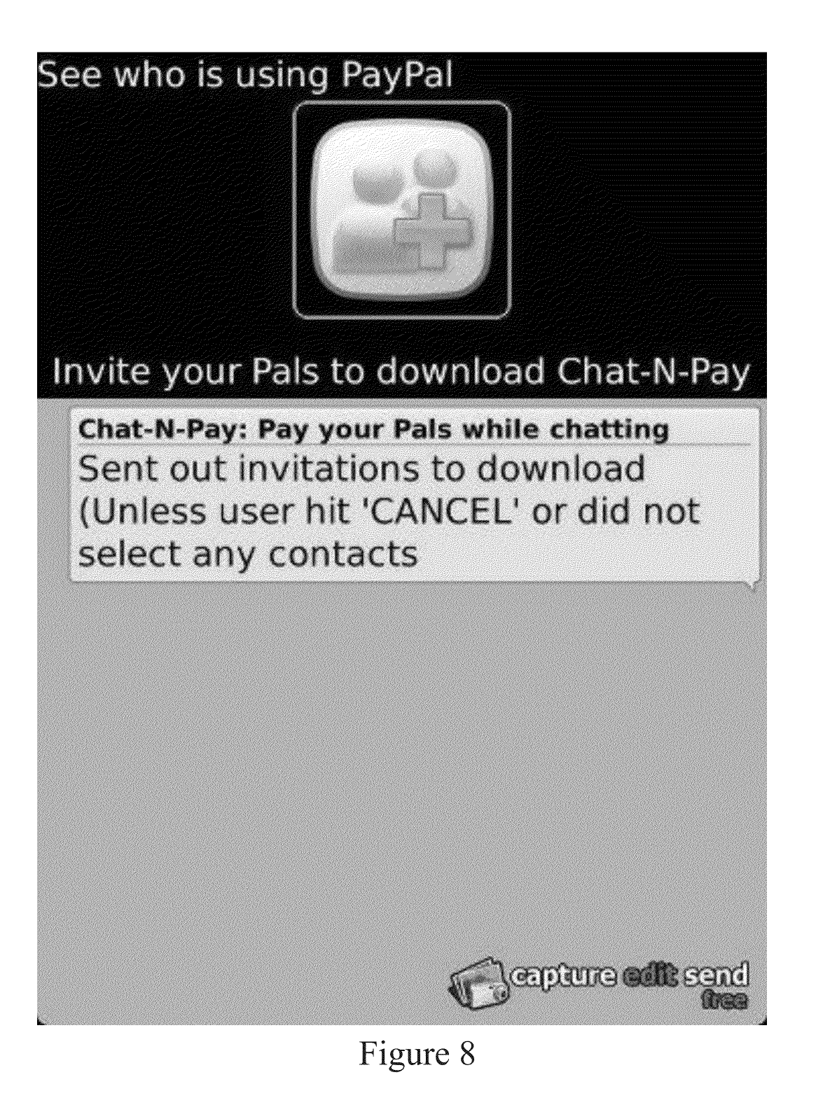

Referring now to FIG. 8, the payment app can also be used to invite friends to join the payment system (e.g., PayPal). In this manner, the payment app can be used with the messaging system to facilitate social sharing. As described above, the payment app can obtain access to messaging system contacts or contacts found in the address book or contact list. These contacts can be shared among a plurality of users and used to invite friends to join the payment system using the functionality provided by an example embodiment.

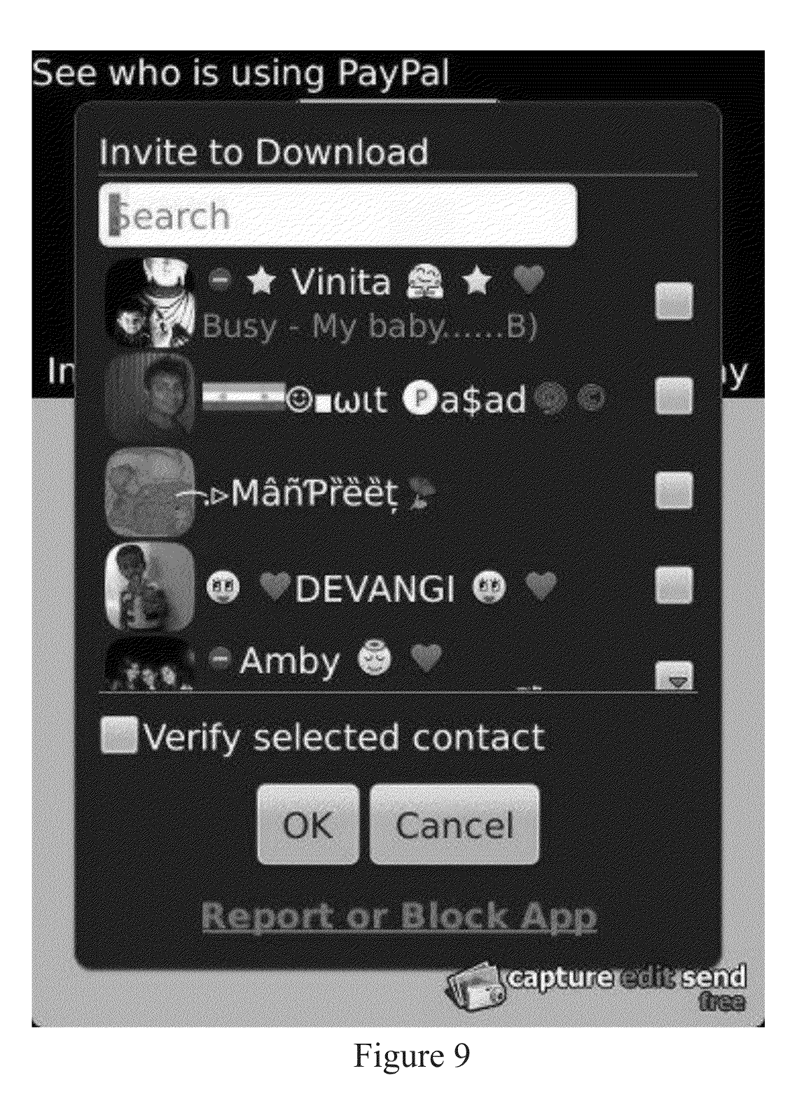

Referring now to FIG. 9, the payment app can also be used to select friend(s) from the available contacts and cause a payment app download request to be sent to the selected friend(s). As part of the payment app download request, the selected friend(s) can receive a link to an App Store from which the payment app can be downloaded immediately by the selected friend(s).

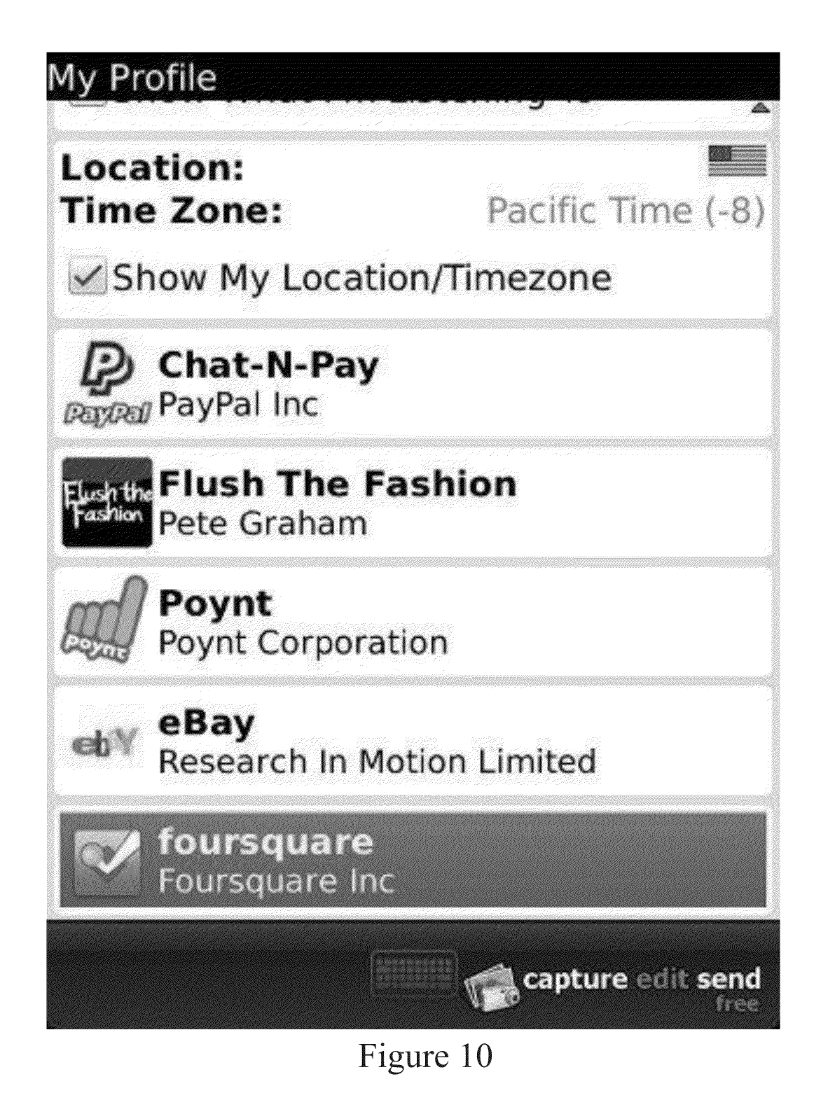

Referring now to FIG. 10, the presence of the payment app within the messaging system is apparent to the user. As a result, users can start chatting with their friends right from the messaging app while performing a payment transaction using the payment app. Additionally, a user's status messages or user profile on the messaging system can be updated to indicate the completion of a payment transaction while chatting. For example, status messages like the following can be displayed within the messaging system: “paid using PayPal to XYZ”, or “bought XYZ using PayPal” or “ordered movie tickets using PayPal.”

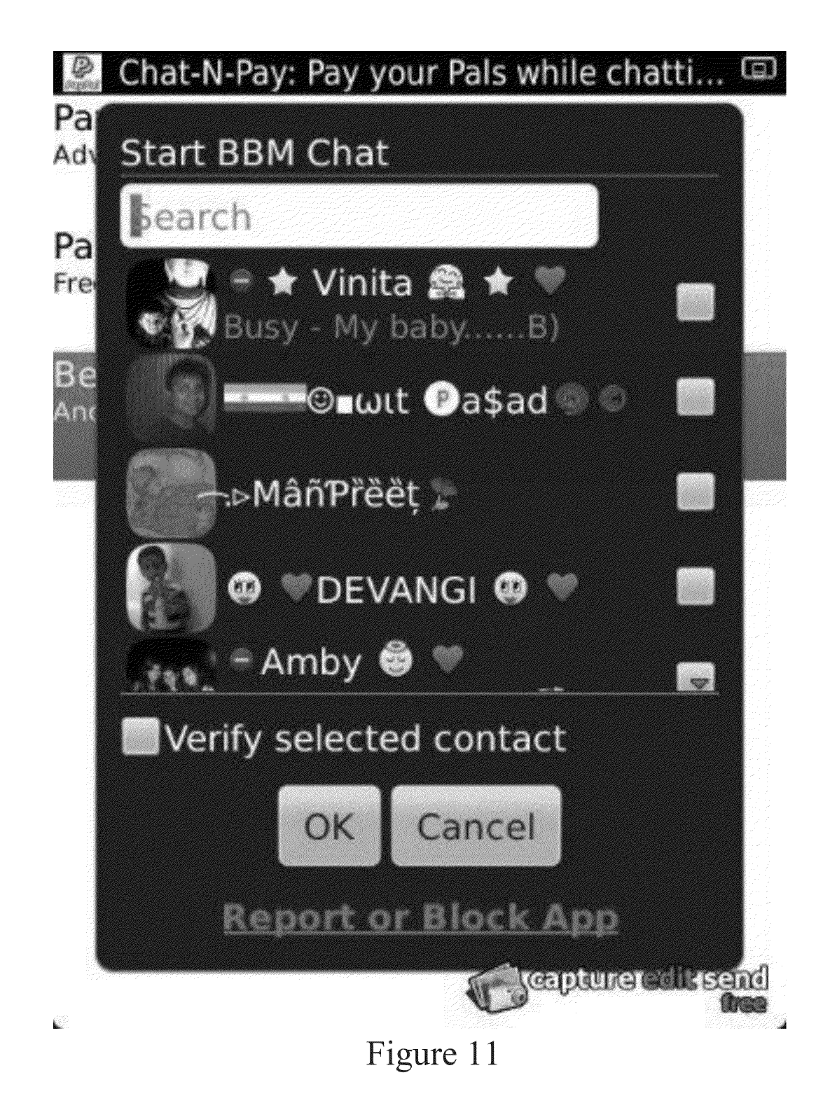

Referring now to FIG. 11, conventional Instant Messaging (IM) clients like BBM have capabilities for creating family groups or class-mates or people sharing common interests/sports. In one embodiment, the payment app of an example embodiment can be configured to automatically activate during long IM conversations, for example, about planning an outing or movie or paying for class notes or booking tickets for the NFL. Additionally, BBM has an API to update a user's IM message after user permission. Also, BBM provides a way to group and show all the recent PayPal activities (a user can disable this). It will be apparent to those of ordinary skill in the art upon reading this disclosure that capabilities of other conventional IM clients can be similarly exploited to include and/or automatically activate the payment-with-chat options provided by the various embodiments disclosed herein.

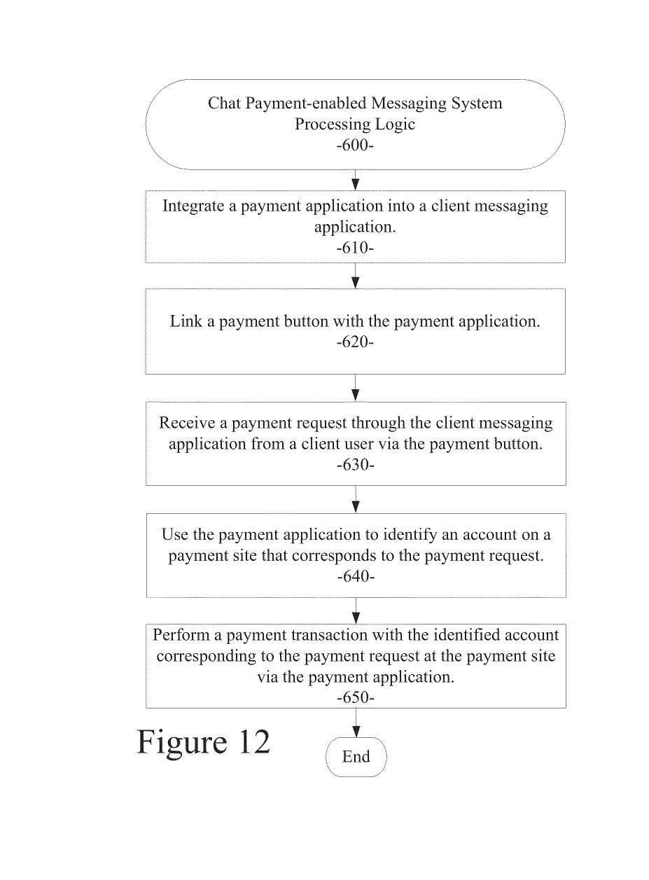

FIG. 12 illustrates a processing flow diagram for an example embodiment 600. In the embodiment 600 shown, a method and apparatus for processing payment transactions from a chat application integrated with a payment application that leverages social features from the chat application includes: integrating a payment application into a client messaging application (processing block 610); linking a payment button with the payment application (processing block 620); receiving, by use of the processor, a payment request through the client messaging application from a client user via the payment button (processing block 630); using the payment application to identify an account on a payment site that corresponds to the payment request (processing block 640); and performing a payment transaction with the identified account corresponding to the payment request at the payment site via the payment application (processing block 650).

While the example embodiment describes separate and distinct message content viewing and payment systems, as examples of messaging and financial systems, it will be appreciated that the described functionality may of course be implemented within the confines of a single system.

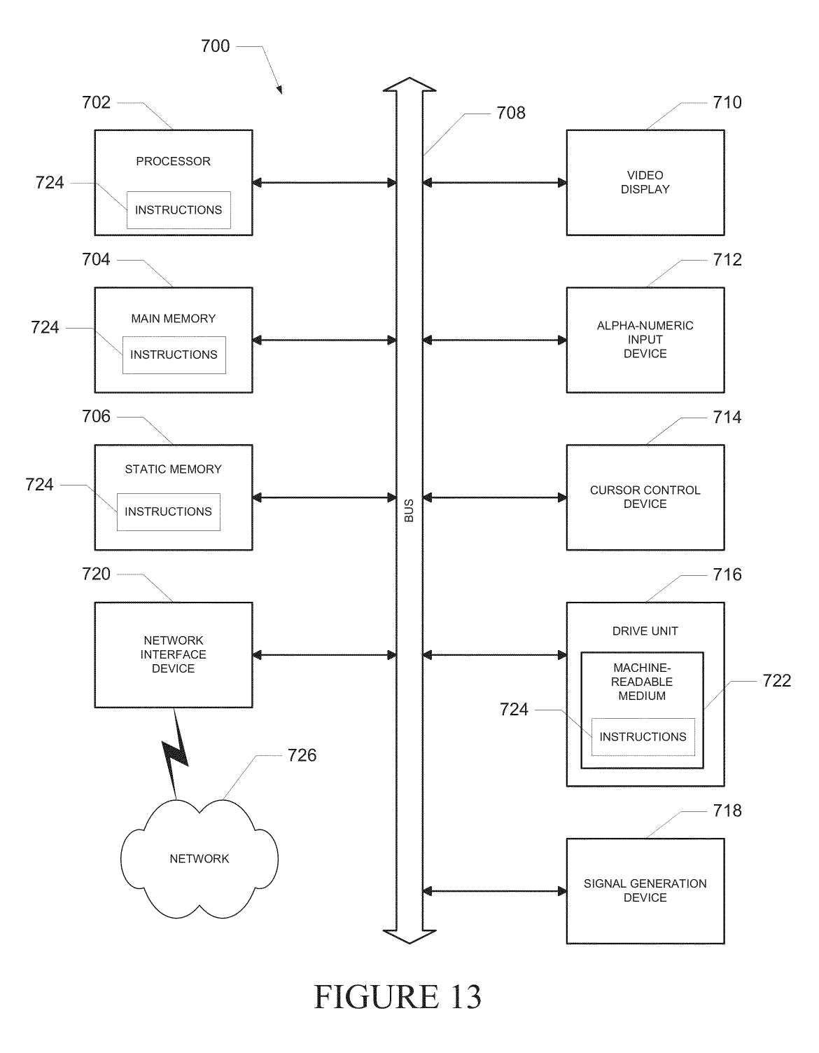

FIG. 13 is a block diagram of machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media. The invention can be implemented in digital electronic circuitry, or in computer hardware, firmware, software, or in combinations of them. The invention can be implemented as a computer program product, i.e., a computer program embodied in a tangible information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method operations of the invention can be performed by one or more programmable processors executing a computer program to perform functions of the invention by operating on input data and generating output. Method operations can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, embodiments may be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may include hardware circuitry, optical components, single or multi-processor circuits, memory circuits, software program modules and objects, firmware, and combinations thereof, as appropriate for particular implementations of various embodiments.

The methods described herein may be performed by processing logic that may comprise hardware (e.g., dedicated logic, programmable logic), firmware (e.g., microcode, etc.), software (e.g., algorithmic or relational programs run on a general purpose computer system or a dedicated machine), or a combination of the above. It will be noted that, in an example embodiment, the processing logic may reside in any of the modules described herein.

Although embodiments of the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, a method and apparatus for processing payment transactions from a chat application integrated with a payment application that leverages social features from the chat application is disclosed. Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
integrating, by use of a processor, a payment application into a client messaging application;
linking a payment button with the payment application;
receiving, by use of the processor, a payment request through the client messaging application from a client user via the payment button;
using the payment application to identify an account on a payment site that corresponds to the payment request; and
performing a payment transaction with the identified account corresponding to the payment request at the payment site via the payment application.

2. The method as claimed in claim 1 including validating the account on the payment site using the payment application.

3. The method as claimed in claim 1 including enabling the client user to select a payee from a contact list of the client messaging application.

4. The method as claimed in claim 1 including performing the payment transaction at the payment site via an application programming interface (API).

5. The method as claimed in claim 1 wherein the client messaging application is a downloadable application on a mobile device.

6. The method as claimed in claim 1 including notifying the client user when the payment transaction is complete.

7. The method as claimed in claim 1 including sending an email to the client user when the payment transaction is complete.

8. The method as claimed in claim 1 including inviting the client user to log-in at the payment site.

9. The method as claimed in claim 1 wherein the client messaging application with the integrated payment application being further configured to facilitate social sharing functions including: inviting users to download the payment application, sharing a contact list among a plurality of payment application users, inviting users to chat right from the payment application, and updating a user profile in the client messaging application by the payment application.

10. An article of manufacture comprising a non-transitory machine-readable storage medium having machine executable instructions embedded thereon, which when executed by a machine, cause the machine to:
integrate a payment application into a client messaging application;
link a payment button with the payment application;
receive a payment request through the client messaging application from a client user via the payment button;
use the payment application to identify an account on a payment site that corresponds to the payment request; and
perform a payment transaction with the identified account corresponding to the payment request at the payment site via the payment application.

11. The article of manufacture as claimed in claim 10 being configured to validate the account on the payment site using the payment application.

12. The article of manufacture as claimed in claim 10 being configured to enable the client user to select a payee from a contact list of the client messaging application.

13. The article of manufacture as claimed in claim 10 being configured to perform the payment transaction at the payment site via an application programming interface (API).

14. The article of manufacture as claimed in claim 10 wherein the client messaging application is a downloadable application on a mobile device.

15. The article of manufacture as claimed in claim 10 being configured to notify the client user when the payment transaction is complete.

16. The article of manufacture as claimed in claim 10 being configured to send an email to the client user when the payment transaction is complete.

17. The article of manufacture as claimed in claim 10 being configured to invite the client user to log-in at the payment site.

18. The article of manufacture as claimed in claim 10 wherein the client messaging application with the integrated payment application being further configured to facilitate social sharing functions including: inviting users to download the payment application, sharing a contact list among a plurality of payment application users, inviting users to chat right from the payment application, and updating a user profile in the client messaging application by the payment application.

19. A system comprising:
a processor;
a memory coupled to the processor to store information related to user messaging and payments; and
a client messaging module to:
integrate a payment application into a client messaging application; link a payment button with the payment application; receive a payment request through the client messaging application from a client user via the payment button; use the payment application to identify an account on a payment site that corresponds to the payment request; and perform a payment transaction with the identified account corresponding to the payment request at the payment site via the payment application.

20. The system as claimed in claim 19 wherein the client messaging application with the integrated payment application being further configured to facilitate social sharing functions including: inviting users to download the payment application, sharing a contact list among a plurality of payment application users, inviting users to chat right from the payment application, and updating a user profile in the client messaging application by the payment application.
